(19) United States
(12) Patent Application Publication
(10) Pub. No.: US 2006/0189837 A1
(43) Pub. Date: Aug. 24, 2006

(54) Method for heavy metal stabilization and cementious agglomeration of flyash and scrubber residues

(76) Inventor: Keith Edward Forrester, Meredith, NH (US)

Correspondence Address: Keith Edward Forrester, 78 Tracy Way, Meredith, NH, 03253, US

(21) Appl. No.: 11/352,891

(22) Filed: Feb. 13, 2006

Related U.S. Application Data
(60) Provisional application No. 60/654,991, filed on Feb. 22, 2005.

(51) Int. Cl. B09B 3/00; A62D 3/00

(52) U.S. Cl. 588/256

(57) ABSTRACT

This invention provides a method for stabilization of flyash and scrubber residues subject to acid and water leaching tests or leach conditions by addition of stabilizing agents and agglomeration effort, such that leaching of lead and regulated heavy metals are inhibited to desired levels. The resultant waste after stabilization and compaction is suitable for disposal as RCRA non-hazardous waste.

### BACKGROUND OF THE INVENTION

Heavy metal bearing air pollution unit collected flyash and air pollution control unit generated scrubber residue combinations from mass burn refuse incinerators, refuse derived fuel incinerators, wood combustors, fossil fuel combustors, steel mills, foundries, and smelters may be deemed “Hazardous Waste” by the United States Environmental Protection Agency (USEPA) pursuant to 40 C.F.R. Part 261 and also deemed hazardous under similar regulations in other countries such as Japan, Switzerland, Germany, United Kingdom, Mexico, Australia, Canada, Taiwan, European Countries, India, and China, and deemed special waste within specific regions or states within those countries, if containing designated leachate solution-soluble and/or sub-micron filter-passing particle sized Lead (Pb) and other regulated heavy metals such as Arsenic (As), Barium (Ba), Cadmium (Cd), Silver (Ag), Mercury (Hg), Selenium (Se), and Chromium (Cr) above levels deemed hazardous by those country, regional or state regulators.

Scrubber residue is most commonly a lime-based solid product produced from the interaction between either dry or slurry lime as CaO or CaO—X(H20) and acid gas components derived from the combustion of refuse or fossil fuels, processing of steel, alloys and other industrial operations which generate acid emission gases such as carbon dioxide, sulfur dioxides and hydrogen chlorides, all of which are regulated under the Clean Air Act and Amendments thereto. Some scrubbers referred to as dry lime scrubbers operate by injecting a fine-powder dry semi-hydrated lime prior to a baghouse collection unit which allows lime to establish a layer onto baghouse fabric filter surfaces and thereafter allows for acid gas reaction and conversion into calcium substituted minerals such as calcium carbonates, calcium sulfates, and calcium chloride. The dry lime injection method produces, by lime usage rate and baghouse layer jet pulse removal rate design, an excess and unreacted lime content in the scrubber residue due to incomplete lime consumption by acid gas. Dry scrubbers operate at a high excess stoichiometric level to assure that acid gases are controlled to permitted levels. Most modem scrubbers use lime in a water slurry hydrated on-site in mixing units and injected into a spray tower reactor prior to the baghouse which provides for more efficient lime consumption and conversion of acid gases to solid calcium products, and thus lower lime excess remaining in the scrubber residue stream removed from the baghouse filters. Both dry and slurry scrubber methods produce excess lime in the scrubber residue. The excess lime in scrubber residue is beneficial to this patent method as the excess calcium oxide and calcium oxide acid gas reaction products act as binders, and with iron, silicates, aluminum and aggregate particles introduced by flyash addition, has a combined flyash scrubber residue blend consistency close to Portland cement.

Flyash is comprised mostly of inorganic fine particles which are entrained within the flue gas derived from a refuse or fossil fuel combustion grate or as fine particles light enough to be air entrained from a steel mill, foundry or casting operation. Flyash and scrubber residue is commonly captured and removed from the facility exhaust in a combined form within a cyclone and/or baghouse collector. Given current Clean Air Act requirements, cyclones alone do not meet the particulate and micron particulate control requirements, and thus are often removed or operated in series with a higher efficiency collection baghouse collector.

Flyash and scrubber residues are becoming more often separated from bottom ash from the combustion of refuse and coal, and thus require separate means for dust control, chemical stabilization and physical stabilization. Bottom ash from refuse combustion has become permitted for use in construction materials and roadbase in several countries such as Taiwan and Germany, and is likely to become approved in the US, Europe and Japan within the decade. Most flyash and scrubber residues remain mixed, and flyash and scrubber residues are commonly stabilized and wetted for dust control in pellet mills, pug mills or batch weigh paddle mixers which all require water injection for ash hydration and assistance for chemical stabilization as required by the country solid and hazardous waste regulations. Water injection can produce undesirable generation of off-gas reaction products such as ammonia (from excess urea found in flyash and scrubber residue which was injected in the gas stream for nitrous oxide emission control) and phosphene or hydrogen sulfide from TCLP stabilization injection of phosphates or sulfides, and acid formations such as sulfuric, hydrochloric and phosphoric produced with the water and exothermic heat due to water hydration of unreacted scrubber residue lime. The generation of such off-gas reaction products and acid formers is often caused when using phosphoric acid Pb stabilization due to a high percentage use of stabilizing acid, such as 5% to 15% by weight of FASR use of 75% H3PO4. Such current ash and scrubber residue conditioners and mixers produce a fine free flowing larger particle ash which is less fugitive than ash feedstock, and often require special reactors and air venting to limit corrosion and meet OSHA air space requirements due to the high phosphoric acid or sulfide product usage and resulting acid gas reaction products such as H2S, H3PO4 acid mist, and phosphene.

In the United States, any industrial solid waste such as collected flyash and scrubber residue can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosivity, (3) reactivity, and (4) toxicity as tested under the Toxicity Characteristic Leaching Procedure (TCLP). 40 C.F.R., Part 261.24(a), contains a list of heavy metals and their associated maximum allowable concentrations. If a heavy metal, such as lead, exceeds its maximum allowable concentration from a solid waste, when tested using the TCLP analysis as specified at 40 C.F.R. Part 261 Appendix 2, then the solid waste is classified as RCRA Hazardous Waste. The USEPA TCLP test uses a dilute acetic acid either in de-ionized water (TCLP fluid 2) or in de-ionized water with a sodium hydroxide buffer (TCLP fluid 1). Both extract methods attempt to simulate the leachate character from a decomposing trash landfill in which the solid waste being tested for is assumed to be disposed in and thus subject to rainwater and decomposing organic matter leachate combination . . . or an acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for specific heavy metals. The TCLP test is designed to simulate a worst-case leaching situation . . . that is a leaching environment typically found in the interior of an actively degrading municipal landfill. Such landfills normally are slightly acidic with a pH of approximately 5±0.5. Countries outside of the US also use the TCLP test as a measure of leaching such as Thailand, Taiwan, and Canada. Thailand also limits solubility of Cu and Zn, as these are metals of concern to Thailand groundwater. Switzerland, Mexico, Europe and Japan regulate management of solid wastes by measuring heavy metals and salts as tested by a sequential leaching method using carbonated water simulating rainwater, synthetic rainwater and de-ionized water sequential testing. Additionally, U.S. EPA land disposal restrictions prohibit the land disposal of solid waste leaching in excess of maximum allowable concentrations upon performance of the TCLP analysis. The land disposal regulations require that hazardous wastes are treated until the heavy metals do not leach at levels from the solid waste at levels above the maximum allowable concentrations prior to placement in a surface impoundment, waste pile, landfill or other land disposal unit as defined in 40 C.F.R. 260.10.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of lead and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached lead is then analyzed by Inductively-Coupled Plasma (ICP) after filtration of a 100 ml aliquot from the tumbler through a 45 micron glass bead filter.

The present invention provides an improved, safer and less costly method of flyash and scrubber residue agglomeration and reduction of the solubility of Pb, Cd, As, Cr, Hg and other heavy metals within flyash and scrubber residue combinations produced from refuse incinerators, wood combustors, fossil fuel combustors, smelters, steel mills and foundries which utilize acid gas scrubbing technology incorporating calcium oxide (Ca0) in either hydrated or non-hydrated form. Pb and other heavy metals such as Cd are controlled by the invention under TCLP, SPLP, CALWET, MEP, rainwater and surface water leaching conditions as well as under regulatory water extraction test conditions as defined by waste control regulations in Thailand, Taiwan, Japan, Canada, UK, Mexico, Switzerland, Germany, Sweden, The Netherlands and under American Nuclear Standards for sequential leaching of wastes by de-ionized water. Unlike the present invention, prior art has focused on reducing solubility of Pb in ash residues by application of stabilizers such as cement, sulfides, silicates and water soluble phosphoric acid (Forrester U.S. Pat. No. 5,245,114) and use of a water insoluble and polymer coated phosphate sources (Forrester U.S. Pat. No. 5,860,908) without definition of the optimal combinations of phosphate, silicates, sulfides, cement and water combination for low cost combined Pb, Cd, As, Cr, Hg stabilization and physical agglomeration into a free flowing dust free matrix. Stabilization and physical agglomeration with cement combination and low phosphate and sulfide without excess water introduction will avoid acid formations within ash mixing and handling equipment and off-gas water driven reaction products such as ammonia, phosphene, and hydrogen sulfide. These previous methods also fail to recognize the value of dry stabilization introduction prior to existing air pollution control equipment and ducting which eliminates the need for expensive down-stream chemical feeders and mixing devices. In-line pre-APC stabilizer introduction also provides for stabilization of all particulates produced, including sub-micron particulates, which escape the baghouse collectors by design. A major advantage of the in-line dry chemical stabilization is thus that escaped stack gas particulates are converted to a less soluble and less bioavailable form prior to emission, and thus the environmental and health risk ranking of particulates exposed to receptors in the stack plume impact areas are greatly diminished. As fixed air pollution sources are regulated as the contribution to air gaseous pollution as well as impact to receptors exposed to gas emissions and heavy metals, the reduction of heavy metal bioavailability can greatly reduce the modeled heavy metals impact in health based risk assessments, and this improve the chance that the facility will be either permitted or allowed in increase production. A majority of flyash and scrubber residue stabilization systems used to date have also benefited from the dilution of the heavy metals in flyash and scrubber residue through bottom ash mixing, and thus providing the mixture of combined ash to pass the subject regulatory leaching test. Many of the flyash and scrubber residue ash conditioning systems and stabilization mixers used to date do not form an ash matrix suitable for direct disposal, as the flyash and scrubber residue is intended for mixing with the bottom ash where it is entrained within the larger bottom ash matrix. The bottom ash in refuse incinerators is 90% to 50% of the combined ash weight depending on whether the incinerator is a mass-burn facility or a refuse-derived fuel plant which removed ferrous, glass and non-ferrous metals prior to the remaining fluff combustion. Bottom ash is always quenched after the grate combustion discharges and wet, thus providing a suitable disposal sink for flyash and scrubber residues that would otherwise remain in a potentially dusty form after simple conditioning in a pugmill, pellet or batch blending unit.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

### SUMMARY OF THE INVENTION

The present invention discloses a Pb, Cd, As, Cr, and Hg bearing flyash and scrubber residue mixture stabilization method through contact of flyash and scrubber residue with stabilizing agents including sulfates, sulfides, carbonates, silicates, Portland cement, cement kiln dust, phosphates, and combinations thereof which are properly chosen to complement the regulated metals substitution into low solubility form minerals in combination with agglomeration which utilizes the flyash, scrubber residue and stabilizer combination physical and chemical nature as a self-binding material suitable for agglomeration without introduction of high water content into the ash and residue agglomeration device. The introduction of Portland cement has also been found to complement the agglomeration of the flyash scrubber residue while also reducing the amount of more costly chemical stabilizer required to meet regulatory limits.

It is anticipated that this method can be used for both reactive compliance and remedial actions as well as proactive leaching reduction means such that generated ash and residue does not exceed hazardous waste criteria. The preferred method of application of stabilizer agents would be in-line within the ash and residue collection units, and thus allowed under USEPA regulations (RCRA) as totally enclosed, in-line exempt method of TCLP stabilization without the need for a RCRA Part B hazardous waste treatment and storage facility permit.

### DETAILED DESCRIPTION

Environmental regulations throughout the world such as those developed by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a less soluble form, thus passing leach tests and allowing the wastes to be either reused on-site or disposed at local landfills without further and more expensive control means such as hazardous waste disposal landfills or facilities designed to provide metals stabilization. The primary focus of scientists has been on reducing solubility of heavy metals such as lead, cadmium, chromium, arsenic and mercury, as these were and continue to be the most significant mass of metals contamination in our environment. Materials such as paints, cleanup site wastes such as battery acids, and industrial operations produced ash and scrubber wastes from fossil fuel combustors, smelters and incinerators are major lead sources.

Scrubber residue is most commonly a lime-based solid product produced from the interaction between either dry or slurry lime as CaOH or CaOH(x) and acid gas components derived from the combustion of refuse , wood or fossil fuels, processing of steel, smelters, and foundries and other industrial operations which generate gases as sulfur dioxides and hydrogen chlorides regulated under the Clean Air Act and Amendments thereto. Some scrubbers referred to as dry lime scrubbers operate by injecting a fine-powder dry lime prior to a baghouse collection unit, which produces a high level of excess lime in the scrubber residue due to incomplete lime consumption by acid gas. Most scrubbers use a wet slurry lime, hydrated on-site in mixing units and injected into a spray tower which provides for a very efficient lime consumption and lower lime excess remaining in the scrubber residue stream. Both scrubber methods produce excess lime and thus a residue with exothermic nature upon hydration.

There exists a demand for improved and less costly control methods of soluble lead and regulated heavy metals from flyash and scrubber residues that allows for Pb and metals stabilization into stable minerals such as phosphate apatite or lead silicate without the high costs of single stabilizer addition such as phosphoric acid or sulfides and the control requirements of such for acids and off-gas reaction products. The present invention discloses a Pb and metals bearing flyash and scrubber residue mixture ash stabilization method through contact with stabilizing agent including phosphates, cements, cement kiln dust, silicates, sulfides, sulfates, carbonates, and combinations thereof, and physical agglomeration for dusting control and separate ash and scrubber residue handling and disposal.

It is anticipated that the method can be used for RCRA compliance actions such that generated waste does not exceed appropriate TCLP hazardous waste criteria, and under TCLP or CERCLA (Superfund) response where stabilizers are added to waste piles or storage vessels previously generated. The preferred method of application of stabilizers would be in-line within the ash and residue handling systems, and thus allowed under RCRA as a totally enclosed, in-line or exempt method of TCLP stabilization without the need for a RCRA Part B hazardous waste treatment and storage facility permit(s).

The stabilizing agents including silicates, sulfates, sulfides, carbonates, cement, cement kiln dust, calcium phosphates, phosphates, and combinations thereof with the phosphate group including but not limited to wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof, and combination with physical agglomeration means would be selected through laboratory treatability and/or bench scale testing to provide sufficient control of metals solubility. In certain cases, such as with the use of amber and green phosphoric acid acid, phosphates may embody sulfuric acid, vanadium, iron, aluminum and other complexing agents which could also provide for a single-step formation of heavy metal minerals and agglomeration. The stabilizer and physical control type, dose rate, contact duration, and application means would be engineered for each type of ash and scrubber residue production facility.

Although the exact stabilization formation minerals are undetermined at this time, it is expected that when lead and regulated heavy metals comes into contact with the stabilizing agents in the presence of flyash and scrubber residue and sufficient agglomeration, reaction time and energy, low extract fluid soluble minerals form such as a Pb substituted hydroxyapatite, through substitution or surface bonding, which is less soluble than the heavy metal element or molecule originally in the material or waste. The combination of sufficient stabilizer and physical agglomeration will provide a dual control method of lead and metals solubility control . . . which is important in applications where complete formation of low soluble lead and metals minerals is not achieved. Such incomplete lead and metals mineral formation environments could occur where phosphates are consumed by iron and calcium within the ash and residue, where available stabilizer levels are too low for complete Pb or metals stabilization, where stabilizer to lead and metals contact is incomplete. Varied agglomeration means will produce varied ash and scrubber stabilization contact, and thus varied stabilization results.

As leach tests used throughout the world also vary as to extractor size, sample size, tumbling method, extract fluid (i.e., water, acetic acid, citric acid, synthetic rainwater, carbonated water, distilled water), the optimum range will be obtained through varying degrees of agglomeration as well as Pb and metals stabilizer dose. One skilled in the art of laboratory treatability studies will be able to develop two-dimensional dose-response relationships for a specific ash and residue combination and specific leaching method, and thus determine the best cost means of stabilization and agglomeration combination.

Examples of suitable stabilizing agents include, but are not limited to sulfates, sulfides, silicates, cements, cement kiln dust, calcium phosphates, phosphate fertilizers, phosphate rock, pulverized phosphate rock, calcium orthophosphates, monocalcium phosphate, dicalcium phosphate, tricalcium phosphate, trisodium phosphates, natural phosphates, phosphoric acids, dry process technical grade phosphoric acid, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof. Examples of suitable agglomeration means include screw mixers, pellet mills, pug mills and rotary tumblers.

The amounts and types of stabilizing agent and agglomeration units used, according to the method of invention, depend on various factors including desired solubility reduction potential, leaching test method, desired mineral toxicity, and desired mineral formation relating to toxicological and site environmental control objectives. It has been found that addition of 20% water plus 4% dicalcium phosphate plus 10% Portland cement by weight of incinerator ash and scrubber residue with pug mill agglomeration was sufficient for TCLP Pb stabilization to less than RCRA 5.0 ppm limit. It has also been found that 20% water plus 3% wet process phosphoric acid plus 15% Portland cement by weight of incinerator ash and scrubber residue with pug mill agglomeration was sufficient for TCLP Pb stabilization to less than RCRA 5.0 ppm limit. However, the foregoing is not intended to preclude yet higher or lower usage of stabilizing agent(s), agglomeration agents, or combinations.

The examples below are merely illustrative of this invention and are not intended to limit it thereby in any way.

### EXAMPLE

Mass burn refuse incinerator flyash and slurry method scrubber residue combination produced from a municipal waste incinerator facility in the United States was mixed with a standard water content of 20% required for dust control, agglomeration, and hydration for assistance of chemical mineral formations, and various weight percent combinations of wet process phosphoric acid (P), triple super phosphate (T), dicalcium phosphate (D), sodium sulfide flake (S), and Portland cement (C) to evaluate the effectiveness and cost savings of stabilizer and cement combinations and agglomeration methods. The mixtures were subjected to agglomeration in a laboratory vertical table mixing device for 15 seconds at medium speed. All samples were cured at for 24 hours and subjected to TCLP analyses Method 1311 and extract digestion by EPA method 200.7.

TABLE 1

| Addition (% weight ash) | TCLP Pb (ppm) | |
|---|---|---|
| | | Cost ($ USD/ton ash) |
| Baseline | 127.00 | 0 |
| 4T | 16.5 | 12 |
| 4D | 27.8 | 8 |
| 4P | 19.0 | 16 |
| 4S | 24.8 | 20 |
| 4C | 58.0 | 4 |
| 15C | 21.5 | 15 |
| 3T + 15C | 0.8 | 24 |
| | | Cost ($ USD) |
| 3P + 15C | 1.0 | 27 |
| 4D + 15C | 2.2 | 23 |
| 4S + 15C | 1.4 | 35 |
| 10P | 0.5 | 40 |
| 10T | 0.05 | 30 |

The foregoing results in Example 1 readily established the operability of the present process to stabilize lead and heavy metal bearing ash and scrubber residue thus reducing leachability to less than the regulatory limit. Given the effectiveness of the stabilizing agents and agglomeration in causing lead and metals to stabilize as presented in the Table 1, it is believed that an amount of the stabilization and agglomeration equivalent to less than 10% by weight of ash and scrubber residue mixtures should be effective.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of lead and heavy metal bearing flyash and scrubber residue mixtures, comprising contacting flyash and scrubber residue mixture with at least one stabilizing agent and one agglomeration device in an amount effective in reducing the leaching of lead and regulated heavy metals from the flyash and scrubber residue mixture to a level no more than non-hazardous levels as determined in an EPA TCLP test, performed on the stabilized material or waste, as set forth in the Federal Register, vol. 55, no. 126, pp. 26985-26998 (Jun. 29, 1990).

2. The method of claim 1, wherein the stabilizing agent is selected from the group consisting of phosphates, sulfates, sulfides, silicates, Portland cement, cement kiln dust, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. A method of claim 1, wherein the agglomeration device includes pellet units, screw mixers, batch mixers, tumble units and combinations thereof.

4. A method of claim 1 wherein reduction of solubility is to a level no more than non-hazardous levels as determined under leach tests required by regulation in countries other than the USA including but not limited to Switzerland, Mexico, Taiwan, Japan, Thailand, China, Canada, Germany, Europe.

5. A method of claim 1 whereas the flyash and scrubber residue combination is produced from operating facilities including the refuse incinerators, wood combustors, coal combustors, oil combustors, steel mills, primary and secondary smelters, foundries, and casting facilities.

6. A method of reducing the solubility of lead and heavy metal bearing scrubber residue, comprising contacting scrubber residue with at least one stabilizing agent and one agglomeration unit in an amount effective in reducing the leaching of lead and heavy metals from the scrubber residue mixture to a level no more than non-hazardous levels as determined in an EPA TCLP test, performed on the stabilized material or waste, as set forth in the Federal Register, vol. 55, no. 126, pp. 26985-26998 (Jun. 29, 1990).

7. The method of claim 6, wherein the stabilizing agent is selected from the group consisting of phosphates, sulfates, sulfides, Portland cement, silicates, cement kiln dust, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

8. A method of claim 1, wherein the agglomeration device includes pellet units, screw mixers, batch mixers, tumble units and combinations thereof.

9. A method of claim 6 wherein reduction of solubility is to a level no more than non-hazardous levels as determined under leach tests required by regulation in countries other than the USA including but not limited to Switzerland, Mexico, Taiwan, Japan, Thailand, China, Canada, Germany, Europe.

10. A method of claim 6 whereas the scrubber residue is produced from operating facilities including the refuse incinerators, wood combustors, coal combustors, oil combustors, steel mills, primary and secondary smelters, foundries, and casting facilities.

11. A method of reducing the solubility of lead and heavy metal bearing flyash, comprising contacting flyash with at least one stabilizing agent and one agglomeration effort in an amount effective in reducing the leaching of lead and heavy metals from the flyash to a level no more than non-hazardous levels as determined in an EPA TCLP test, performed on the stabilized ash, as set forth in the Federal Register, vol. 55, no. 126, pp. 26985-26998 (Jun. 29, 1990).

12. The method of claim 11, wherein the stabilizing agent is selected from the group consisting of phosphates, sulfates, sulfides, Portland cement, silicates, cement kiln dust, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

13. A method of claim 1, wherein the agglomeration device includes pellet units, screw mixers, batch mixers, tumble units and combinations thereof.

14. A method of claim 11 wherein reduction of solubility is to a level no more than non-hazardous levels as determined under leach tests required by regulation in countries other than the USA including but not limited to Switzerland, Mexico, Taiwan, Japan, Thailand, China, Canada, Germany, Europe.

15. A method of claim 11 whereas the flyash and scrubber residue are produced from operating facilities including the refuse incinerators, wood combustors, coal combustors, oil combustors, steel mills, primary and secondary smelters, foundries, and casting facilities.
